(19) United States
(12) Patent Application Publication
(10) Pub. No.: US 2003/0029859 A1
(43) Pub. Date: Feb. 13, 2003

(54) Lamphead for a rapid thermal processing chamber

(75) Inventors: Peter A. Knoot, San Carlos, CA (US); Paul Steffas, Santa Clara, CA (US)

Correspondence Address: APPLIED MATERIALS, INC., 2881 SCOTT BLVD. M/S 2061, SANTA CLARA, CA, 95050, US

(73) Assignee: Applied Materials, Inc.

(21) Appl. No.: 09/925,208

(22) Filed: Aug. 8, 2001

(51) Int. Cl. H05B 1/02; F27D 11/00

(52) U.S. Cl. 219/483; 219/486; 219/501; 118/725; 219/390

(57) ABSTRACT

A semiconductor processing system and method. The system includes an assembly of radiant energy sources and a programmable switch array configured to selectively deliver power to each radiant energy source based on a plurality of control signals. The method includes measuring the temperature at a plurality of regions on a substrate and controlling a plurality of radiant energy sources to correct any non-radial temperature discontinuities.

### BACKGROUND OF THE INVENTION

This invention relates generally to a semiconductor processing system and, more specifically, to a semiconductor processing system having an improved lamphead.

Rapid thermal processing (RTP) systems are employed in semiconductor chip fabrication to create, chemically alter or etch surface structures on semiconductor wafers. One such RTP system, as described in U.S. Pat. No. 5,155,336, which is assigned to the assignee of the subject application and which is incorporated herein by reference, includes a semiconductor processing chamber and a heat source assembly or lamphead located on the semiconductor processing chamber.

A number of infrared lamps are located in the lamphead. During processing, radiation from the lamps radiates through an upper window, light passageways and a lower window onto a rotating semiconductor substrate in the processing chamber. In this manner, the wafer is heated to a required processing temperature.

The lamphead may include a number of light pipes to deliver highly collimated radiation from tungsten-halogen lamps to the processing chamber. The lamps are divided into multiple zones, which are located in a radially symmetrical manner. Each zone is separately powered by a silicon controlled rectifier (SCR) driver that is, in turn, controlled by a multi-input, multi-output controller. The lamps are connected to the SCR drivers through a large wiring collar and heavy-duty electrical cabling.

Present RTP chamber designs present a number of problems that significantly increase the cost of ownership. Present RTP systems can draw a maximum continuous current of 165 amperes (A) per chamber, with peak currents reaching 200 A during temperature ramping. The duty cycle (that is, the portion of the processing cycle during which power is required) is about 40% for typical RTP processes. For a mainframe populated with four RTP chambers, the facilities requirements are 208 volts (V), 980 A. This results in expensive system facilitization costs, as well as an obstacle to customer penetration in countries with power usage restrictions. The low duty cycle also results in inefficient delivery of power to the lamps, low power factor, noise, and harmonics.

Present RTP systems also have large relatively, expensive lamphead power cables. The cable pairs which connect the SCR drivers to the lamphead are each typically 2 AWG in order to carry 100 A at 208 V. The cable bundle is thick and relatively rigid, causing problems with ease of service of the lamphead. The cable bundle is also relatively expensive.

Present RTP systems typically have an expensive, hand-wired lamp wiring collar assembly. The lamps are powered through this wiring collar. The assembly is large and very heavy, causing further design problems.

Present RTP systems typically have hard-wired lamp zones. The lamps are hard-wired into a fixed number of zones, each supplied by a separate SCR driver. This does not permit reconfiguration in order to optimize process performance.

### SUMMARY OF THE INVENTION

In general, the invention is directed to a semiconductor processing system. In one aspect, the invention features an assembly of radiant energy sources, and a programmable switch array configured as part of the assembly of radiant energy sources and configured to selectively deliver power to each radiant energy source based on a plurality of control signals.

Particular implementations can include one or more of the following features. The system can include one or more DC-DC converters configured to receive high-voltage DC power and to deliver low-voltage bipolar DC power to the programmable switch array. The system can include an energy storage unit configured to receive a constant-current power input and to provide a variable-current power output to the one or more DC-DC converters. The energy storage unit can include a capacitor bank.

The system can include a transformer configured to receive an AC power supply, and a full wave bridge coupled to the transformer and configured to produce the constant-current power input. The programmable switch array can include at least one of a PMOS FET (field effect transistor) and an IGBT (isolated gate bipolar transistor).

In another aspect, the invention features a lamphead for use in semiconductor processing. The lamphead includes an assembly of radiant energy sources, a switching array and a programmable assignment matrix. The switching array includes a plurality of switches through which power is delivered to the radiant energy sources based on a plurality of control signals. The assignment matrix provides the control signals to selected switches of the switching array.

Particular implementations of the lamphead can include one or more of the following features. The lamhead can include one or more DC converters configured to receive high-voltage DC power and to deliver low-voltage bipolar DC power to the switching array. The lamphead may further include a pulse width modulator that receives the control signals from a controller and produces select signals that are provided to the assignment matrix. The radiant energy sources, the switching array, the assignment matrix, the one or more DC converters, and the pulse width modulator can be formed as part printed circuit board structure.

In yet another aspect, the invention features a method for use in a semiconductor processing system. The method includes measuring the temperature at a plurality of regions on a substrate, and controlling a plurality of radiant energy sources to correct any non-radial temperature discontinuities detected by the measuring step.

Among the advantages of the invention are the following. Lamp zones are programmable, permitting individual lamp control. High-voltage DC power distribution within the lamphead permits reduced-diameter cabling. The power factor of the lamphead is reduced 50% over present designs. Cost is also reduced.

Other features and advantages of the invention will be apparent from the following detailed description, the accompanying drawings and the claims.

### BRIEF DESCRIPTION OF THE DRAWINGS

Embodiments of the invention are further described by way of examples with reference to the accompanying drawings wherein:

FIG. 1 is schematic side view of a semiconductor processing system according to one embodiment;

FIG. 2 is a block diagram of a lamphead assembly power control system.

FIG. 3 schematically illustrates a programming scheme for a lamphead assembly in which the lamps in the same zone receive the same signal.

FIG. 4 schematically illustrates another programming scheme in which the lamps in the same zone receive different signals.

Like reference numbers and designations in the various figures indicate like elements.

### DETAILED DESCRIPTION OF THE INVENTION

A semiconductor processing system including a heat source assembly and a semiconductor-processing chamber are described. In the following description, specific details are set forth in order to provide a thorough understanding of the invention. It will be appreciated, however, by one skilled in the art, that the invention may be practiced without these specific details. In other instances, well-known elements have not been shown in order to avoid unnecessarily obscuring the invention.

In the following description, the term substrate is intended to broadly cover any object that is being processed in a thermal process chamber and the temperature of which is being measured during processing. The term substrate includes, for example, semiconductor wafers, flat panel displays, glass plates or disks, and plastic workpieces.

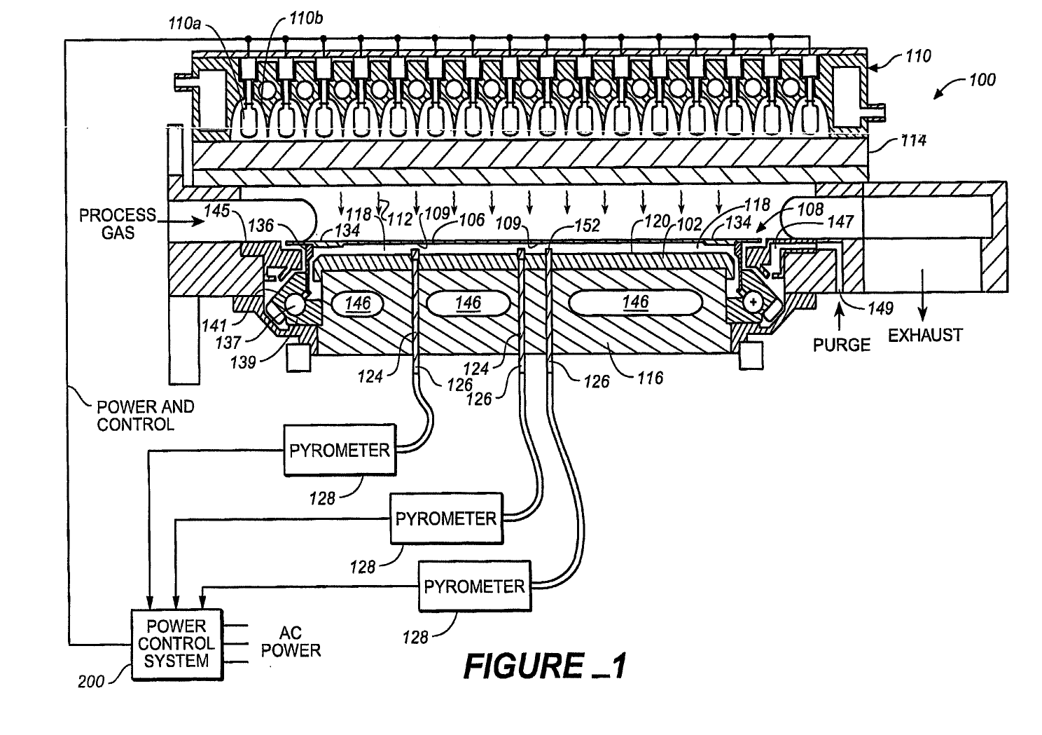

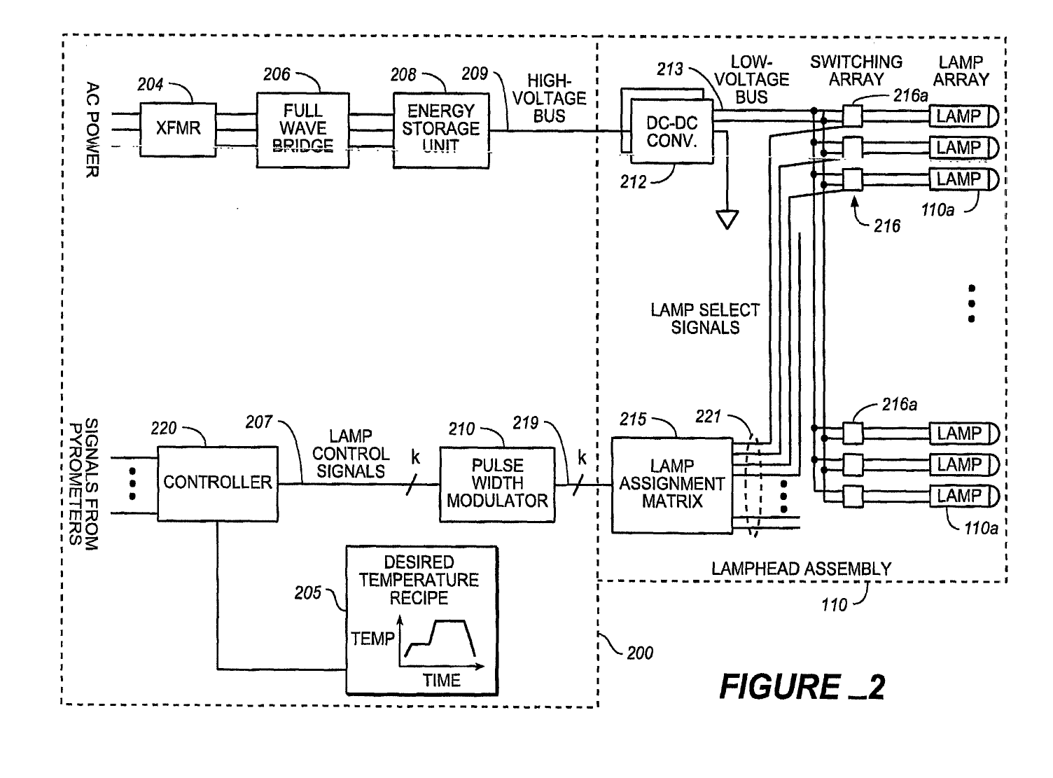

An RTP system that has been modified in accordance with one embodiment of the invention is shown in FIGS. 1-2. The RTP system includes a processing chamber 100 for processing a silicon substrate 106. For example, the substrate 106 can be a disk-shaped eight-inch (200 mm) or twelve-inch (300 mm) diameter silicon wafer. The substrate 106 is mounted inside the chamber on a substrate support structure 108 and is heated by a heating element or lamphead assembly 110 located directly above the substrate. The lamphead assembly can include a plurality of individual lamps 110a located within reflectors 110b. There may be one reflector for each lamp. The reflectors may be individual light pipes or some sort of other reflector assembly.

The heating element 110 generates radiation 112 which is directed to a front side of the substrate and which enters the processing chamber 100 through a water-cooled quartz window assembly 114. Beneath the substrate 106 is a reflector 102, which is mounted on a water-cooled, stainless steel base 116. The base 116 includes a circulation circuit 146 through which coolant circulates to cool the reflector and reflecting surface. Water, which is above 23° C., is circulated through the base 116 to keep the temperature of the reflector well below that of the heated substrate. The reflector 102 is made of aluminum and has a highly reflective surface coating 120. An underside or backside 109 of the substrate 106 and the top of reflector 102 form a reflecting cavity 118 for enhancing the effective emissivity of the substrate.

The separation between the substrate and reflector may be approximately 0.3 of an inch (7.6 mm), thus forming a cavity, which has a width-to-height ratio of about 27. In processing systems that are designed for eight-inch silicon wafers, the distance between the substrate 106 and the reflector 102 is between about 3 and 9 millimeters (mm). The width-to-height ratio of the cavity 118 should be larger than about 20:1. If the separation is made too large, the emissivity-enhancement effect that is attributable to the virtual blackbody cavity that is formed will decrease. On the other hand, if the separation is too small, for example, less than about 3 mm, then the thermal conduction from the substrate to the cooled reflector will increase, thereby imposing an unacceptably large thermal loss on the heated substrate, since the main mechanism for heat loss to the reflecting plate will be conduction through the gas. The thermal loss will, of course, depend up the type of process gas and the chamber pressure during processing.

The temperature at localized regions of the substrate 106 are measured by a plurality of temperature probes or sensors 152. Each temperature probe can include a sapphire light pipe 126 that passes through a conduit 124 that extends from the backside of the base 116 through the top of the reflector 102. The sapphire light pipe 126 is about 0.125 inch in diameter and the conduit 124 is slightly larger. The sapphire light pipe 126 is positioned within the conduit 124 so that its uppermost end is flush with or slightly below the upper surface of the reflector 102. The other end of light pipe 126 couples to a flexible optical fiber that transmits sampled light from the reflecting cavity to a pyrometer 128.

Each pyrometer and associated probe measures the temperature of a region of the substrate. Each pyrometer is connected to a power control system 200, which controls the power supplied to the heating element 110 in response to a measured temperature. As noted, the heating element includes a plurality of lamps that are housed within a reflector assembly. Each reflector assembly includes a reflective inner surface. The reflective inner surface is made of any suitable light reflecting material such as gold-plated aluminum. The open ends of the reflector assembly are located adjacent to the window 114.

In one embodiment, the lamps are radiation emitting light bulbs such as tungsten-halogen lamps. For processing a 200 mm wafer, for example, the lamphead assembly may include 187 lamps divided into 12 zones which are located in a radially symmetrical manner. A lamphead assembly for processing a 300 mm wafer may include 409 lamps divided into 15 zones. The lamp zones can be individually adjusted by the control system 200 to allow controlled radiative heating of different areas of the substrate 106. In addition, as discussed below, individual lamps can be controlled independently.

Since the substrate can be rotated between about 90 and 240 revolutions (rpm) and temperature measurements are made at different radial locations on the backside of the substrate, each temperature probe or sensor produces an average temperature over a different annular region of the substrate. A controller 220 of the control system 200 (see FIG. 2) receives temperature measurements that are generated by the temperature sensors, corrects the temperatures based upon a temperature correction algorithm and adjusts the power level of the lamps to achieve a substrate temperature as specified by a pre-defined temperature cycle profile 205 that is supplied to the controller 220. Throughout the process cycle, the controller automatically adjusts the power levels delivered to the different control groups so that any temperature deviations away from the desired temperature profile may be corrected. A type of controller is described in U.S. Pat. No. 5,755,511, assigned to the assignee of the present invention, the entire disclosure of which is incorporated herein by reference.

The support structure which rotates the substrate includes a support or edge ring 134 which contacts the substrate around the substrate's outer perimeter, thereby leaving all of the underside of the substrate exposed except for a small annular region about the outer perimeter. The support ring 134 has a radial width of approximately one inch (2.5 centimeters (cm)). To minimize the thermal discontinuities that will occur at the edge of the substrate 106 during processing, the support ring 134 is made of the same, or similar, material as the substrate, for example silicon or silicon carbide.

The support ring 134 rests on a rotable tubular quartz cylinder 136 that is coated with silicon to render it opaque in the frequency range of the pyrometers. The silicon coating on the quartz cylinder acts as a baffle to block out radiation from the external sources that might contaminate the intensity measurements. The bottom of the quartz cylinder is held by an annular upper bearing 141 which rests on a plurality of ball bearings 137 that are, in turn, held within a stationary, annular, lower bearing race 139. The ball bearings 137 are made of steel and are coated with silicon nitride to reduce particulate formation during operation. The upper bearing race 141 is magnetically coupled to an actuator (not shown), which rotates the cylinder 136, the support ring 134 and the substrate 106 during thermal processing.

The magnetically-rotated support ring is used in chambers configured to process 300 mm wafers. It is further described in U.S. Pat. No. 6,157,106, assigned to the assignee of the present invention, the entire disclosure of which is incorporated herein by reference.

A purge ring 145 that is fitted into the chamber body surrounds the quartz cylinder. The purge ring 145 has an internal annular cavity 147 which opens up to a region above upper bearing race 141. The internal cavity 147 is connected to a gas supply (not shown) through a passageway 149. During processing, a purge gas is flowed into the chamber through the purge ring 145.

The support ring 134 has an outer radius that is larger than the radius of the quartz cylinder so that it extends out beyond the quartz cylinder. The annular extension of the support ring beyond the cylinder 136, in cooperation with the purge ring 145 located below it, functions as a baffle, which prevents stray light from entering the reflecting cavity at the backside of the substrate. To further reduce the possibility of stray light reflecting into the reflecting cavity, the support ring 134 and the purge ring 145 may also be coated with a material that absorbs the radiation generated by the heating element 110, for example, a black or gray material.

During processing, a process gas can be introduced into the space between the substrate and the window assembly 114 through an inlet port. Gases are exhausted through an exhaust port, which is coupled to a vacuum pump (not shown).

As shown in FIG. 2, the lamphead power control system 200, in one configuration, includes a transformer (XFMR) 204, a full wave bridge 206, an energy storage unit 208, a pulse width modulator 210, a lamp assignment matrix 215, and the controller 220. The lamphead or heating element 110 includes one or more DC-DC converters 212, a solid state switching array 216, and a plurality of lamps 110a which, as discussed, are located in a reflector assembly.

The assignment matrix 215, as illustrated, can be located in the lamphead assembly. The pulse width modulator 210 can also be part of the lamphead assembly.

The transformer 204 and full wave bridge 206 receive three-phase AC power, for example, 208 volts at 400A, and convert the AC power to DC power. The transformer rating for this embodiment is 600 kVA.

The energy storage unit 208 receives constant-current DC power from the full wave bridge 206, and delivers variable-current high-voltage (on the order of 1000 VDC) DC power on a high-voltage bus 209.

The energy storage unit 208 is sized to allow for delivery of the maximum current demands of the RTP system when required, while recharging during periods of low lamp activity. Thus, it smoothes out the power demands of the processing system. The energy storage unit 208 preferably includes a capacitor bank sized according to methods well-known in the art. For example, the energy storage unit may have a capacity of approximately 1,000 farads.

The energy storage unit output, as noted, is a high DC voltage on the bus 209. This permits the use of lower gauge, less inexpensive cables for power delivery to the lamphead assembly 110. Specifically, the use of a 1000 VDC power bus results in a two-wire, eight AWG lamp power cable connection to the lamphead assembly. This reduces cabling cost and permits better design options for chamber lid opening and servicing.

The high voltage DC power is reduced to a low-voltage, bipolar DC power, for example, ±50 VDC, within the lamphead assembly 110 using the DC-DC converters 212. The voltage of the low-voltage bipolar DC power can be selected according to the type of lamp filament being used. Multiple DC-DC converters 212 can be used for redundancy and reliability.

The low-voltage DC power is supplied over a bus 213 to the switching array 216. The switching array includes a solid-state switch 216a, for example, a PMOS FET (field effect transistor) or IGBT (isolated gate bipolar transistor), at each lamp to control the application of the low-voltage DC power to the lamps. The switching array 216 replaces the SCR drivers used in previous RTP systems. The switching array receives lamp select signals from the assignment matrix 215 as described below.

The controller 220 receives signals representing substrate temperature measurements from the pyrometers 128. The controller 220 functions as described above to produce analog lamp control signals which are fed to the pulse width modulator 210 over a bus 207. Each lamp control signal is a voltage level within a predetermined voltage range. A typical voltage range is 0-10 VDC. The pulse width modulator 210 receives k signals, for example, one for each lamp zone. The pulse width modulator 210 produces k lamp select signals, one for each lamp zone. Each output of the pulse width modulator 210 is a square wave on a bus 219, with a pulse width proportional to the voltage level of the corresponding lamp control signal.

The k lamp select signals are provided to the assignment matrix 215. The matrix 215 selectively controls delivery of power to each lamp 218 based on the k signals and the programming of the matrix. The number of outputs of the matrix is equal to the number of lamps in the lamphead assembly. The lamp select signals are delivered over lines 221 to the respective switches of the individual lamps. The matrix is programmed to deliver respective lamp select signals to the switches of the switching array 216 for those lamps which are assigned to the same control zone.

The assignment matrix 215 and the switching array 216 act as programmable switching array. The assignment matrix 215 is the logic portion of the programmable array, and the switching array 216 is the power delivery portion of the programmable array. The assignment matrix determines which switches of the switching array, and thus their associated lamps, are in which particular groups or zones. The programmable array can be programmed to accommodate any configuration of lamp zones and/or to control individual lamps.

The assignment matrix can be implemented in hardware or software. A hardware implementation would include hardware logic on a printed circuit board. A software implementation could include software logic in the software module used to control the overall RTP system. The software logic, as well as the pulse width modulator 210, could also be implemented in the controller 220.

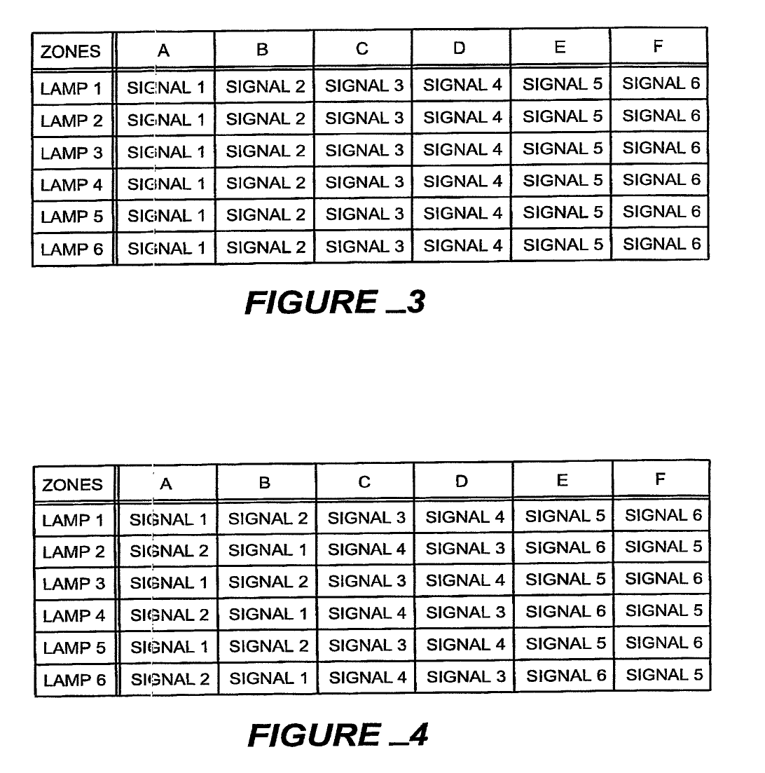

By way of a simplified example, as shown by the matrix of FIG. 3, the lamphead assembly may include six approximately concentric zones (Zones A-E),with each zone including six lamps (Lamps 1-6). There are six lamp control signals and thus six lamp select signals (Signals 1-6). The assignment matrix is programmed to apply the same signal to each lamp of a particular zone. That is, for instance, Signal 1 is applied to each of the Lamps 1-6 of Zone A.

Also, as shown in FIG. 4, in another operating scheme, the lamps of each zone have two different select signals applied to them. That is, for instance, Signal 1 is applied to Lamps 1, 3 and 5 of Zone A, while Signal 2 is applied Lamps 2, 4 and 6 of Zone A.

An advantage of this latter mode of operation is that non-radial temperature discontinuities in the substrate can be corrected for, as adjacent lamps in the same concentric zone receive different select signals. By way of explanation, what is meant by non-radial temperature discontinuities is, for example, those temperature discontinuities that may be present about an annular region of the substrate as opposed to those that may exist across a radius of the substrate. The temperature sensors, of course, would have to be appropriately positioned to provide temperature readings along the same annual region of the substrate.

The above-described level of programmability allows for rapid customization of lamphead assemblies for different process needs. The programming can be changed to implement different processes or even during processing. Intelligent algorithms can be used to compensate for differences in lamp intensity, variations among and within substrates, and lamp failures. For instance, in the case of a lamp failure in a particular zone, the loss of power can be compensated for by increasing the power to other lamps in that zone.

The control algorithms can perform automatic calibration of the lamps based on feedback from the pyrometers. The programmable switch array can be programmed to correct for non-radial temperature discontinuities, because the lamps need not be operated in concentric zones, as described in above-mentioned U.S. Pat. No. 5,755,511. Indeed, the lamps may be operated in almost any pattern desired. The way in which the lamps are operated is simply a function of the number of control signals and lamps in a particular lamphead assembly, and the manner in which the assignment matrix is programmed to apply the control signals to the individual lamps.

The lamps and reflectors described above have a one-to-one correspondence. However, in an alternative arrangement, multiple lamps or radiant energy sources may be surrounded by a single reflector. Also, the reflectors may be concentrically arranged so that the cylindrical reflectors with large diameters surround not only multiple radiant energy sources, but also reflectors with smaller diameters. Such arrangements are described in U.S. Pat. No. 6,072,160, which is assigned to the assignee of the subject application the entire disclose of which is incorporated herein by reference.

The DC-DC converters 212, the switching array 216, the pulse width modulator 210, and the assignment matrix 215 can all be integrated onto a single printed circuit board (PCB) structure within the lamphead assembly. The lamps 218 plug directly into the PCB structure, which requires only a 1000 VDC power connection and a connection for the lamp control signals. All other wiring is eliminated. Such a PCB structure is described in U.S. patent application Ser. No. 09/710,518, filed Nov. 9, 2000, entitled A POWER DISTRIBUTION PRINTED CIRCUIT BOARD FOR A SEMICONDUCTOR PROCESSING SYSTEM, assigned to the assignee of the present invention, the entire disclosure of which is incorporated herein by reference.

While certain exemplary embodiments have been described and shown in the accompanying drawings, it is to be understood that such embodiments are merely illustrative and not restrictive of the current invention, and that this invention is not restricted to the specific constructions and arrangements shown and described, since modifications may occur to those ordinarily skilled in the art.

What is claimed is:

1. A system for use in semiconductor processing comprising:
an assembly of radiant energy sources; and
a programmable switch array configured as part of said assembly and configured to selectively deliver power to each radiant energy source based on a plurality of control signals.

2. The system of claim 1 further comprising:
one or more DC-DC converters configured to receive high-voltage DC power and to deliver low-voltage bipolar DC power to the programmable switch array.

3. The system of claim 2 further comprising:
an energy storage unit configured to receive a constant-current power input and to provide a variable-current power output to the one or more DC-DC converters.

4. The system of claim 3 wherein the energy storage unit comprises a capacitor bank.

5. The system of claim 3 further comprising:
a transformer configured to receive AC power; and
a full wave bridge coupled to the transformer and configured to produce the constant-current power input.

6. The system of claim 1 wherein the programmable switch array includes a plurality of solid state switches configured to deliver power to each of said radiant energy sources.

7. The system of claim 6, wherein the switches include at least one of a PMOS FET and an IGBT.

8. The system of claim 6 wherein the programmable switch array further includes an assignment matrix that is programmable to selectively deliver power to each radiant energy source.

9. The system of claim 8 further including a controller configured to produce the control signals in response to signals from a plurality of sensors which are indicative of a substrate temperature.

10. The system of claim 9 wherein a pulse width modulator receives the control signals and produces select signals that are supplied to the assignment matrix.

11. A lamphead for use in semiconductor processing comprising:
an assembly of radiant energy sources;
a switching array including a plurality of switches through which power is delivered to the radiant energy sources based on a plurality of control signals; and
a programmable assignment matrix to provide the control signals to selected switches of the switching array.

12. The lamphead of claim 11 further including one or more DC-DC converters configured to receive high-voltage DC power and to deliver low-voltage bipolar DC power to the switching array.

13. The lamphead of claim 12 further including a pulse width modulator that receives the control signals from a controller and produces select signals that are provided to the assignment matrix.

14. The lamphead of claim 13 wherein the radiant energy sources, the switching array, the assignment matrix, the one or more of DC-DC converters, and the pulse width modulator are formed as part of a printed circuit board structure.

15. A method for use in a semiconductor processing system comprising:
measuring the temperature at a plurality of regions of a substrate; and
controlling a plurality of radiant energy sources to correct any non-radial temperature discontinuities detected by the measuring step.
